(19) United States
(12) Patent Application Publication
(10) Pub. No.: US 2024/0328562 A1
(43) Pub. Date: Oct. 3, 2024

(54) PIPELINE PIG HANDLING APPARATUS

(71) Applicants: Jeremy Nichols, Crooked Creek (CA); Jacob Joseph Tosczak, Crooked Creek (CA)

(72) Inventors: Jeremy Nichols, Crooked Creek (CA); Jacob Joseph Tosczak, Crooked Creek (CA)

(21) Appl. No.: 18/193,047

(22) Filed: Mar. 30, 2023

(51) Int. Cl. F16L 55/46

(52) U.S. Cl. CPC F16L 55/46

(57) ABSTRACT

A pipeline pig handling apparatus configured to provide loading and unloading of pipeline pigs and ensure a safe process thereof. The apparatus of the present invention includes a frame wherein the frame is partitioned into a first portion and a second portion. The first portion of the frame houses the drive unit wherein the drive unit includes a drive motor, a power supply, an oil reservoir, a drive ram brace unit and a ram shaft. The drive motor is operably coupled to the ram shaft and configured to provide hydraulic movement thereof. The second portion of the frame houses the plunger chamber wherein the plunger chamber further includes a plunger movably disposed therein. The plunger chamber is contiguously formed with a concentric reducer wherein the concentric reducer has a portion thereof that extends beyond an end plate of the frame and is configured with a pipe clamp.

### FIELD OF THE INVENTION

The present invention relates generally to pipeline operations, more specifically but not by way of limitation, a pipeline pig handling apparatus that facilitates the loading and unloading of a pipeline pig wherein the present invention provides a safe and efficient process to accomplish the aforementioned.

### BACKGROUND

As is known in the art, pipeline pigs are routinely utilized in the maintenance of various different types of pipelines. There are various different types of pipeline pigs but the two general types are utilized for cleaning and inspection of the pipeline. While pipeline pigs can be provided in alternate sizes, they are generally capsule shaped and will clean the inner surface of the pipeline as they traverse therethrough. Pipeline pigs achieved their name from the squealing noise that is made as the device travels through the pipeline. The pipeline pig is inserted into a launcher wherein the launcher is configured to introduce the pipeline pig into the pipeline by creating a pressure differential.

There are many potential hazards when engaged in loading and/or unloading of a pipeline pig. One hazard is the potential exposure to high pressure gas or condensate to the operator attempting to load/unload the pipeline pig. Additionally, the physical exertion required to operate manual process valves and handling of the pig itself can present potential physical hazards for the individual responsible for the task of loading/unloading a pipeline pig. Furthermore, the risk of the escape and subsequent ignition of hydrocarbon gas can be a significant risk to an individual loading/unloading a pipeline pig. Common precautions currently utilized to protect an individual from the aforementioned hazards and others encountered in the pipeline handling process include but are not limited to the use of PPE equipment, minimizing exposure to the launcher barrel and ensuring depressurization of the launcher barrel prior to opening. All of these risks and more are prevalent in the maintenance and operation of pipelines.

Accordingly, there is a need for a pipeline pig handling apparatus that is operable to provide a safer and more efficient technique of loading and unloading pipeline pigs.

### SUMMARY OF THE INVENTION

It is the object of the present invention to provide a pipeline pig handling apparatus configured to provide loading of a pipeline pig into a pipeline wherein the apparatus of the present invention is contained within a frame.

Another object of the present invention is to provide a pipeline pig apparatus that is configured to provide a safe technique to load or unload pipeline pigs wherein the frame of the present invention includes a bottom configured to receive and retain spills.

A further object of the present invention is to provide a pipeline pig handling apparatus configured to provide loading of a pipeline pig into a pipeline wherein the apparatus of the present invention includes a drive motor wherein the drive motor is mounted at the rear end of the frame.

Still another object of the present invention is to provide a pipeline pig apparatus that is configured to provide a safe technique to load or unload pipeline pigs wherein the frame further has mounted thereto a power supply and a fuel supply for the drive motor.

An additional object of the present invention is to provide a pipeline pig handling apparatus configured to provide loading of a pipeline pig into a pipeline wherein the apparatus of the present invention includes a drive shaft operably coupled to the drive motor.

Yet a further object of the present invention is to provide a pipeline pig apparatus that is configured to provide a safe technique to load or unload pipeline pigs that further includes a loading barrel wherein the loading barrel includes a rear portion and a front portion.

Another object of the present invention is to a provide a pipeline pig handling apparatus configured to provide loading of a pipeline pig into a pipeline wherein the front portion of the loading barrel includes an access hatch providing access to the interior volume thereof.

An alternate object of the present invention is to provide a pipeline pig apparatus that is configured to provide a safe technique to load or unload pipeline pigs wherein the loading barrel includes a pipeline adapter contiguously formed therewith.

Still a further object of the present invention is to provide a pipeline pig handling apparatus configured to provide loading of a pipeline pig into a pipeline wherein the pipeline adapter is located exterior of the front end of the frame.

An additional object of the present invention is to provide a pipeline pig apparatus that is configured to provide a safe technique to load or unload pipeline pigs wherein the loading barrel further includes an engagement piston movably disposed within the interior volume thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a detailed view of the first portion of the frame area of the present invention; and

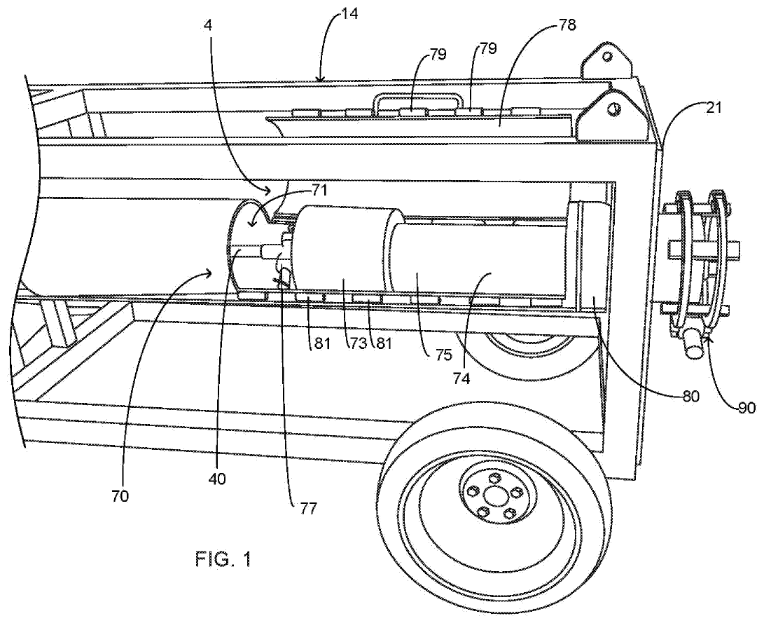

FIG. 2 is a perspective view of the front area of the present invention; and

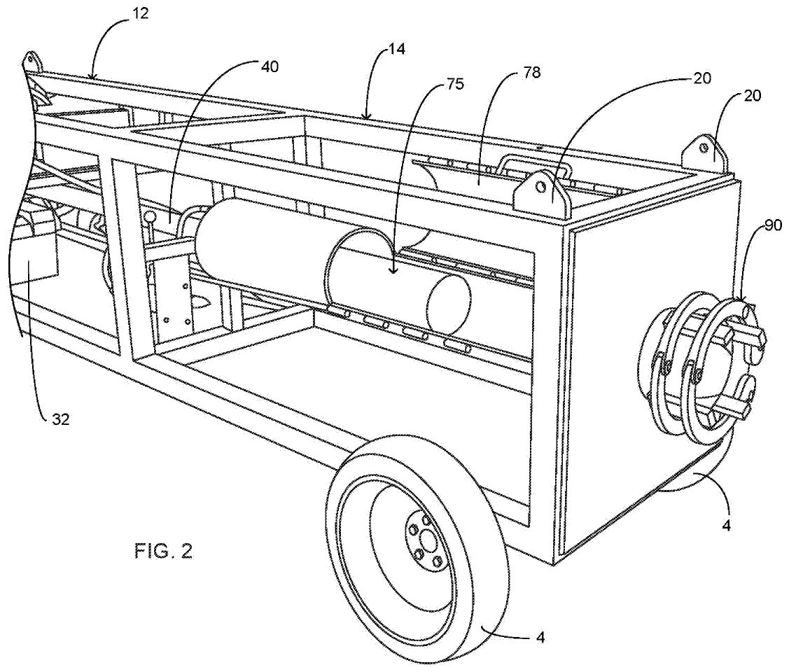

FIG. 3 is a perspective view of the present invention; and

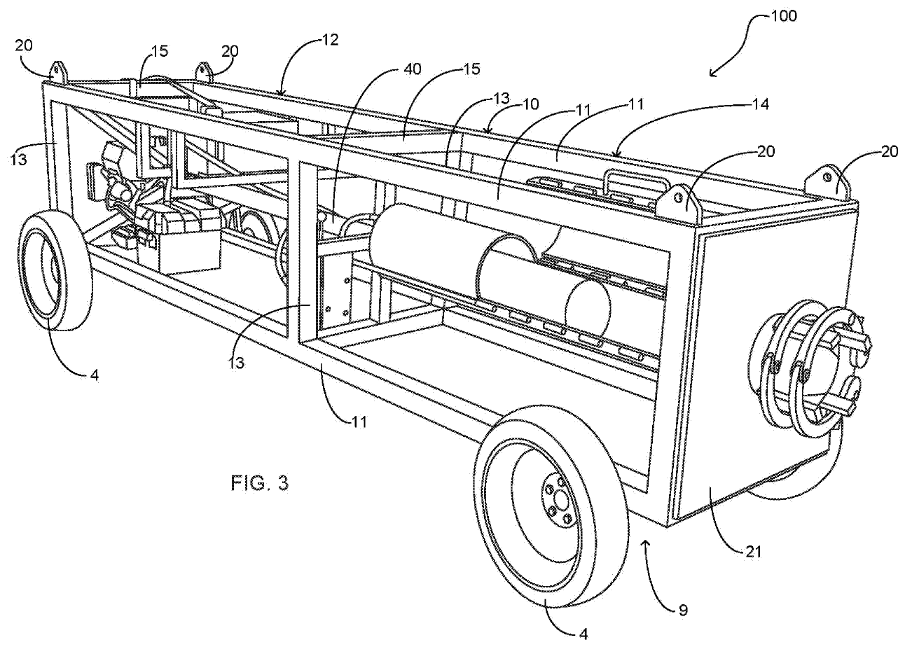

FIG. 4 is a perspective view of the rear portion of the present invention; and

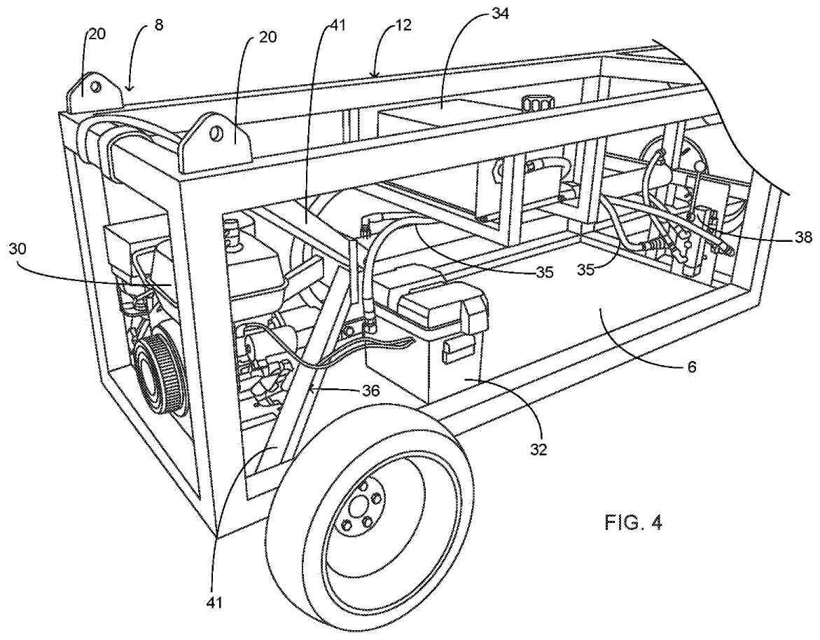

FIG. 5 is a perspective view of exemplary pipeline pigs.

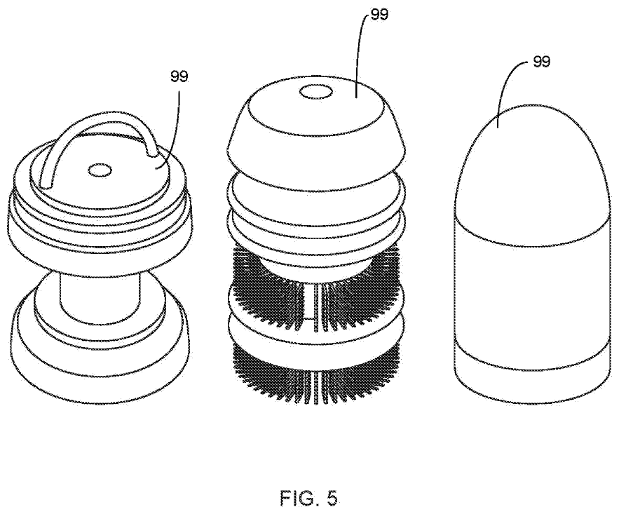

### DETAILED DESCRIPTION

Referring now to the drawings submitted herewith, wherein various elements depicted therein are not necessarily drawn to scale and wherein through the views and figures like elements are referenced with identical reference numerals, there is illustrated a pipeline pig handling apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the pipeline pig handling apparatus 100 includes a frame 10 wherein the frame 10 includes a first portion 12 and a second portion 14. The frame is manufactured from square metal tubing and includes a plurality of longitudinal support members 11, vertical support members 13 and horizontal support members 15. The aforementioned support members are operably coupled utilizing suitable durable techniques such as but not limited to welding. The frame 10 in a preferred embodiment is rectangular in shape but it should be understood within the scope of the present invention that the frame 10 could be formed in alternate shapes. Furthermore, while a preferred embodiment of the frame 10 utilizes support members manufactured from three inch square tubing having a quarter inch wall in thickness, various alternate sizes and shapes of metal tubing could be utilized to manufacture the frame 10. Additionally, while the first portion 12 and second portion 14 of the frame 10 are discussed and illustrated herein as being integrally formed, it is contemplated within the scope of the present invention that the first portion 12 and second portion 14 could be releasably secured wherein the first portion 12 is the drive unit and the second portion 14 is head unit and specifically configured to operably coupled with various sizes of pipeline.

The frame 10 further includes hoist engagement members 20 located at all four corners thereof. The hoist engagement members 20 are secured to the frame 10 utilizing welding or other suitable technique. The hoist engagement members 20 are operable to be secured to a sling or hoist that is utilized to lower the pipeline pig handling apparatus 100 into position for operable coupling with a pipeline. The frame 10 further includes an end plate 21 secured to the second end 9 distal to first end 8. The end plate 21 in a preferred embodiment is manufactured from one half inch thick plate and is operable to inhibit damage to the pipeline pig handling apparatus 100 in the event of various failures during the pipeline pig 99 loading and unloading process.

The first portion 12 of the frame 10 comprises the drive unit of the pipeline pig handling apparatus 100. The drive unit includes the drive motor 30, the power supply 32, oil reservoir 34 and drive ram brace unit 36. The drive motor 30 is a conventional combustible engine and is configured to provide the necessary power to hydraulically operate the ram shaft 40 as is further discussed herein. While no particular size of drive motor is required, good results have been achieved utilizing a drive motor of approximately three hundred and forty eight cubic inches capable of providing seventeen thousands pounds of pressure to the ram shaft 40. The drive motor 30 has the necessary electrical power provided thereto via the power supply 32. The power supply 32 is a conventional twelve volt power supply and can be provided in various sizes as needed to accommodate the requirements of the drive motor 30. An oil reservoir 34 is provided wherein oil reservoir 334 provides the hydraulic oil required to operate the ram shaft 40. The ram shaft 40 is operated in a forward-rearward direction and is controlled via controller 38. The ram shaft 40 is operated like a conventional hydraulic ram and is operably coupled to the plunger 60 as is further discussed herein. The ram shaft 40 is constructed from a solid metal rod and is manufactured of a suitable length to move the plunger 75 the require distance to facilitate the loading of the pipeline pig 99. The first portion 12 of the frame 10 includes bottom member 6 wherein the bottom member 6 is operably to capture and retain any hydraulic oil leak that may occur from the oil reservoir 34 or any tubing 35 operably coupled thereto.

The drive ram brace unit 36 is provided for structural support of the ram shaft 40. The drive ram brace unit 36 comprises four support members 41 that are angularly positioned to converge into a single area wherein the ram shaft 40 is forward thereof. In a preferred embodiment the support members 41 of the drive ram brace unit 36 is manufactured from three inch square tubing but it should be understood within the scope of the present invention that alternate materials and sizes thereof could be utilized.

The second portion 14 of the frame 10 houses the drive unit 4. The drive unit 4 includes plunger chamber 70. The plunger chamber 70 is manufactured from a durable material such as but not limited to metal and is tubular in shape having an interior volume 71. The plunger chamber 70 houses the plunger 75, which is movably disposed therein. The plunger 75 is operably coupled to the ram shaft 40 utilizing coupling 77. Coupling 77 is configured to facilitate the releasable securing of the plunger 75 to the ram shaft 40 and it is contemplated within the scope of the present invention that the coupling 77 could be provided in various alternate configurations. The plunger 75 includes a first portion 73 and second portion 74 that is contiguously formed wherein the second portion 74 has a diameter that is less than that of the first portion 73. The second portion 74 is configured so as to penetrate into the concentric reducer 80 so as to journal the pipeline pig thereinto and beyond so as to be introduced into the pipeline. The plunger chamber 70 includes access door 78 that is hingedly secured thereto so as to provide access to the interior volume 71 for the loading and unloading of the plunger 75 and the pipeline pigs 99. It should be understood within the scope of the present invention that the access door 78 could be provided in alternate sizes in order to provide access to the interior volume 71. The access door 78 includes receiving tubes 79 configured to align with receiving tubes 81 when the access door is moved to a closed position. Once the access door 78 is closed the receiving tubes 79 and receiving tubes 81 are in axial alignment so as to receive a locking rod (not illustrated herein) therethrough in order to maintain the access door 78 in its closed position during loading and unloading of pipeline pigs 99. The plunger 75 is moved forwards and rearwards within the plunger chamber 70 in order to facilitate the loading of the pipeline pigs 99 into the pipeline wherein during the loading procedure the end of the second portion 74 will extend beyond the pipe clamp 90. During removal of pipeline pigs 99 from pipelines utilizing air pressure of alternate techniques, the plunger 75 is removed to allow the pipeline pig 99 to be injected into the interior volume 71 from the pipeline.

The frame 10 includes wheels 4 that are rotatably coupled to each corner of the frame 10. The wheels 4 are conventional wheels and are provided in order to assist in the transportation of the pipeline pig handling apparatus 100. The wheels 4 are configured to be removable when the pipeline pig handling apparatus 100 is lowered into position for operable coupling with a pipeline. It should be understood within the scope of the present invention that the frame 10 could have alternate quantities of wheels and further be provided without wheels.

The concentric reducer 80 is integrally formed with the end plate 21 and operably couples the plunger chamber 70 with a pipeline (not illustrated herein). The plunger chamber 70 is manufactured of a diameter that is larger than that of the pipeline to which the pipeline pig handling apparatus 100 is being operably coupled. The concentric reducer 80 is structured to reduce the interface diameter from the plunger chamber 70 to equal that of the pipeline to which the pipeline pig handling apparatus 100 is operably coupled. By way of example but not limitation the concentric reducer 80 is configured to have a diameter reduction from ten inches to eight inches when the pipeline pig handling apparatus 100 is being operably coupled to an eight inch pipeline. Secured to the end of the concentric reducer 80 is the pipe clamp 90. The pipe clamp 90 is a conventional clamp and is configured to provide the operable coupling of the concentric reducer 80 to the pipeline in order to facilitate the loading or unloading of the pipeline pigs.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A pipeline pig handling apparatus configured to provide loading an unloading of pipeline pigs wherein the pipeline pig handling apparatus comprises:
a frame, said frame having a plurality of support members, said frame being divided into a first portion and a second portion, said frame having a first end and a second end;
a drive unit, said drive unit being disposed in said first portion of said frame, said drive unit including a drive motor, said drive unit further including a power supply and an oil reservoir, said drive unit configured to provide operation of a ram shaft;
a plunger chamber, said plunger chamber being disposed in the second portion of said frame, said plunger chamber having an interior volume, said plunger chamber having a plunger movably disposed within the interior volume, said plunger chamber being operably coupled to said ram shaft; and
wherein said plunger is configured to propel a pipeline pig into a pipeline.

2. The pipeline pig handling apparatus as recited in claim 1, and further including a concentric reducer, said concentric reducer being contiguously formed with said plunger chamber, said concentric reducer having a portion extending beyond the second end of said frame.

3. The pipeline pig handling apparatus as recited in claim 2, wherein said plunger chamber further includes an access door, said access door being hingedly secured to a portion of said plunger chamber.

4. The pipeline pig handling apparatus as recited in claim 3, and further including a pipe clamp, said pipe clamp being secured to the portion of the concentric reducer extending beyond the second end of said frame.

5. The pipeline pig handling apparatus as recited in claim 4, wherein said first portion of said frame further includes a bottom member, said bottom member providing complete coverage of the first portion of the frame so as to retain any oil spilled thereon.

6. The pipeline pig handling apparatus as recited in claim 5, wherein said ram shaft is movably in a rearward-forward direction so as to control operation of the plunger.

7. The pipeline pig handling apparatus as recited in claim 6, wherein said frame further includes a plurality of hoist engagement members, said hoist engagement members configured to provide operable coupling with a hoist sling.

8. A pipeline pig handling apparatus configured to provide loading pipeline pigs wherein the pipeline pig handling apparatus comprises:
a frame, said frame having a plurality longitudinal support members, said frame further having a plurality of vertical support members being operably coupled to said plurality of longitudinal support members, said frame further including a plurality of horizontal support members, said frame being divided into a first portion and a second portion, said frame having a first end and a second end, said frame having a top and a bottom;
a drive motor, said drive motor being a combustible engine motor, said drive motor being disposed in said first portion of said frame;
a ram shaft, said ram shaft being hydraulically controlled by said drive motor;
an oil reservoir, said oil reservoir being disposed in said first portion of said frame;
a plunger chamber, said plunger chamber being disposed in the second portion of said frame, said plunger chamber having an interior volume, said plunger chamber having a plunger movably disposed within the interior volume, said plunger chamber being operably coupled to said ram shaft; and
wherein said plunger is configured to propel a pipeline pig into a pipeline.

9. The pipeline pig handling apparatus as recited in claim 8, wherein said plunger includes a first portion and a second portion, said first portion and said second portion of said plunger being contiguously formed.

10. The pipeline pig handling apparatus as recited in claim 9, and further including a concentric reducer, said concentric reducer being contiguously formed with said plunger chamber, said concentric reducer having a first portion and a second portion, said second portion of said concentric reducer extending beyond the second end of said frame.

11. The pipeline pig handling apparatus as recited in claim 10, and further including a ram shaft brace unit, said ram shaft brace unit configured to provide structural support for said ram shaft, said ram shaft brace unit disposed in said first portion of said frame.

12. The pipeline pig handling apparatus as recited in claim 11, wherein said frame further includes a plurality of hoist engagement members, said hoist engagement members being located on said top of said frame, said hoist engagement members providing an element to couple a lift sling to the frame.

13. The pipeline pig handling apparatus as recited in claim 12, wherein said first portion of said plunger further includes a coupling, said coupling configured to operably couple an end of said ram shaft to said plunger.

14. The pipeline pig handling apparatus as recited in claim 13, wherein said second portion of said concentric reducer has a diameter that is less than a diameter of the first portion of the concentric reducer.

15. A pipeline pig handling apparatus configured to provide loading pipeline pigs wherein the pipeline pig handling apparatus comprises:
a frame, said frame having a plurality longitudinal support members, said frame further having a plurality of vertical support members being operably coupled to said plurality of longitudinal support members, said frame further including a plurality of horizontal support members, said frame being divided into a first portion and a second portion, said frame having a first end and a second end, said frame having a top and a bottom, said first portion of said frame having a bottom member proximate the bottom of said frame, said bottom member configured to receive and retain oil spillage;
a drive motor, said drive motor being a combustible engine motor, said drive motor being disposed in said first portion of said frame;
a ram shaft, said ram shaft having a first end and a second end, said ram shaft being hydraulically controlled by said drive motor, said ram shaft being coupled to a ram shaft brace unit, said ram shaft brace unit configured to provide structural support for said ram shaft, said ram shaft brace unit disposed in said first portion of said frame;
an oil reservoir, said oil reservoir being disposed in said first portion of said frame, said oil reservoir operably coupled to said drive motor;
a plunger chamber, said plunger chamber being disposed in the second portion of said frame, said plunger chamber having an interior volume, said plunger chamber having a plunger movably disposed within the interior volume, said plunger being operably coupled to said second end of said ram shaft, said plunger chamber being operably coupled to said ram shaft;
a concentric reducer, said concentric reducer being contiguously formed with said plunger chamber, said concentric reducer having a first portion and a second portion, said second portion of said concentric reducer extending beyond the second end of said frame
wherein said plunger is configured to propel a pipeline pig into a pipeline.

16. The pipeline pig handling apparatus as recited in claim 15, wherein said second portion of said concentric reducer has a diameter that is less than a diameter of the first portion of the concentric reducer.

17. The pipeline pig handling apparatus as recited in claim 16, wherein said plunger chamber further includes an access door, said access door being hingedly secured to a portion of said plunger chamber.

18. The pipeline pig handling apparatus as recited in claim 17, wherein said first portion of said plunger further includes a coupling, said coupling configured to operably couple an end of said ram shaft to said plunger.

19. The pipeline pig handling apparatus as recited in claim 18, wherein said frame has operably coupled thereto a plurality of wheels.

20. The pipeline pig handling apparatus as recited in claim 19, wherein said frame further includes a plurality of hoist engagement members, said hoist engagement members being located on said top of said frame, said hoist engagement members providing an element to couple a lift sling to the frame.
